(19) United States
(12) Patent Application Publication
(10) Pub. No.: US 2026/0141452 A1
(43) Pub. Date: May 21, 2026

(54) ADAPTIVE LEARNING FOR INVESTMENTS

(71) Applicant: Allio Fintech Corporation, Seattle, WA (US)

(72) Inventors: Joseph Gradante, Lake Oswego, OR (US); Adam Andrew Damko, Oak Creek, WI (US); Andrew Giannone, Collegeville, PA (US); Ling Feng Chen, San Bruno, CA (US); Derek Alan Cornelius Drummond, Colorado Springs, CO (US); Christopher Patrick Egloff, Highlands Ranch, CO (US)

(73) Assignee: Allio Fintech Corporation, Seattle, WA (US)

(21) Appl. No.: 19/281,410

(22) Filed: Jul. 25, 2025

Related U.S. Application Data
(63) Continuation of application No. 19/257,080, filed on Jul. 1, 2025.
(60) Provisional application No. 63/678,329, filed on Aug. 1, 2024.

(51) Int. Cl. G06Q 40/06

(52) U.S. Cl. CPC G06Q 40/0631

(57) ABSTRACT

An embodiment of adaptive learning technology utilizes various machine-learning techniques for financial-market performance, asset-performance forecasting, asset-return forecasting, or investment-portfolio improvement (e.g., investment-portfolio optimization) for financial assets (e.g., individual Exchange-Traded-Funds) of a financial market (e.g., Exchange-Traded Funds (ETFs). The performance or return forecasts (e.g., predictions) can leverage market and other features such as historical market data, interest rates, and macroeconomic indicators. The predictions can be used as the return-expectation inputs for investment-portfolio-improvement (e.g., investment-portfolio-optimization) processes, aiding in the design of various investment-portfolio strategies, and corresponding investment portfolios, with specific constraints. And the output of the portfolio improvement (e.g., optimization) can be, for example, a number (e.g., one hundred sixty (160)) specific constrained strategies and one or more recommended investment portfolios for each of one or more of the strategies.

### PRIORITY CLAIM

This application is a continuation of U.S. application Ser. No. 19/257,080, filed 1 Jul. 2025, is titled “ADAPTIVE LEARNING FOR INVESTMENTS”, which claims the benefit of U.S. Provisional Patent Application Ser. No. 63/678,329, which was filed 1 Aug. 2024, is titled ADAPTIVE LEARNING FOR INVESTMENTS, both of which are incorporated herein by reference in their entireties for all purposes.

### COPYRIGHT NOTICE

This disclosure is protected under United States and/or International Copyright Laws. C 2022. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### INCORPORATION BY REFERENCE OF COMPUTER PROGRAM LISTING APPENDIX

The Computer Program Listing Appendix A, which includes file 20554_003PV1_Altitude.txt, created on 1 Aug. 2024, and having a size of 667 KB, and Appendix B, which is attached, are incorporated by reference for all purposes.

### SUMMARY

An embodiment of adaptive learning technology utilizes various machine-learning techniques for financial-market performance, asset-performance forecasting, asset-return forecasting, or investment-portfolio improvement (e.g., investment-portfolio optimization) for financial assets (e.g., individual Exchange-Traded-Funds) of a financial market (e.g., Exchange-Traded Funds (ETFs). The performance or return forecasts (e.g., predictions) can leverage market and other features such as historical market data, interest rates, and macroeconomic indicators. The predictions can be used as the return-expectation inputs for investment-portfolio-improvement (e.g., investment-portfolio-optimization) processes, aiding in the design of various investment-portfolio strategies, and corresponding investment portfolios, with specific constraints. And the output of the portfolio improvement (e.g., optimization) can be, for example, a number (e.g., one hundred sixty (160)) specific constrained strategies and one or more recommended investment portfolios for each of one or more of the strategies.

Another embodiment includes a structured approach to predicting three-(3)-month-ahead returns for ETFs using the CRISP-DM methodology. By combining historical market data, interest rates, and macroeconomic indicators with advanced machine-learning techniques like LightGBM, robust feature engineering, and selection methods, accurate and reliable predictions can be generated. These predictions can serve as crucial inputs for portfolio improvement (e.g., optimization), facilitating the design of a diverse range of portfolio strategies with specific constraints. The use of Riskfolio-lib's nested clustered optimization methodology can ensure that the portfolios are improved (e.g., optimized) for utility and variance, thus supporting strategic financial decision-making.

### BRIEF DESCRIPTION OF THE DRAWING FIGURES

FIG. 1 is a flow diagram of a procedure (method or workflow) for converting financial data from one format to another format suitable for ingesting by a machine-learning (ML) model, according to an embodiment.

FIG. 2 is a flow diagram of a procedure for generating one or more features of a combination of the properly formatted financial data from FIG. 1 and other financial data, according to an embodiment.

FIG. 3 is a flow diagram of a procedure for building and training an ML model and using the built and trained ML model to predict future performance of a financial market or a segment thereof, according to an embodiment.

FIG. 4 is a flow diagram of a procedure for using the performance of a financial-market or segment predicted according to the procedure of FIG. 3 to build a base investment-portfolio from one or more assets in the financial market or segment thereof, to drive the built base portfolio toward a suitable predicted performance level, and to generate, from the base portfolio, one or more strategy-specific investment portfolios, according to an embodiment.

FIG. 5 is a flow diagram of the combined procedures of FIGS. 1-4 for implementation on the cloud, according to an embodiment.

FIG. 6 is a diagram of a computing system that can perform, execute, or otherwise implement, the embodiments, procedures, workflows, or methods described in conjunction with FIGS. 1-5, according to an embodiment.

FIG. 7 is a snippet of code and a bar graph of a time-series split, according to an embodiment.

FIG. 8 is a graph of an example related to the code of FIG. 7, according to an embodiment.

FIG. 9 is an example list of constraints from the publicly available Riskfolio-lib documentation, according to an embodiment.

### DETAILED DESCRIPTION

In an embodiment, one can use Artificial Intelligence (AI) to analyze macroeconomic data to predict the performance, and possibly other aspects of the market, for financial assets such as Exchange Traded Funds (ETFs), and to use the prediction (either by humans or additional AI) to recommend, to investors, one or more corresponding (e.g., ETF) portfolios in which to invest over a particular period of time. For example, one may use the prediction to develop a new investment portfolio for an investor, or to improve an investor's existing investment portfolio. And the one or more portfolios each can be tailored to a specific strategy, such as growth strategy for an investor with a conservative tolerance for portfolio risk.

As used herein, AI includes the development, training, and use of one or more machine-learning (ML) models, such as convolutional neural networks (CNNs), that contain software code that is executed by one or more computing machines that include one or more computing circuits such as a microprocessor, a microcontroller, a graphics processor, any other suitable computing circuit, or any combination or sub-combination thereof.

Furthermore, although using AI to predict performance, returns, (or possibly other aspects) of the ETF market is described herein for purposes of example, using AI to predict performance, returns, (or possibly other aspects) of other financial markets (e.g., the growth-stock market, the mid-cap-stock market, the short-term-bond market) according to the techniques described herein is contemplated.

In an embodiment, there are a number of steps for using AI to predict the ETF market.
1) A first step is to acquire macroeconomic financial data relative to the ETF market in a form that a trained ML model can accept.
2) A second step is to train the ML model on/with the macroeconomic financial data acquired in the first step.
3) A third step is to determine what subset of the macroeconomic financial data to feed to the trained ML model to obtain suitable (e.g., best or optimal) predictions under different risk-preference scenarios.
4) A fourth step is to acquire and feed the determined financial data subset (in proper format) relative to the ETF market to the trained ML model to predict future performance or returns of the ETF market over a particular time period or particular time window (e.g., over the next three months).
5) A fifth step, which instead may be considered part of the fourth step, is to continually update the training for, e.g., to retrain, the ML model.
6) And a sixth step is to use the predicted future ETF performance as an input to a nested clustered improvement (e.g., optimization) algorithm with specific constraints for portfolio strategies (e.g., one hundred sixty portfolio strategies) to output a respective one or more strategy weights for each portfolio strategy, where the constraints or strategies can include recommendations of one or more individual ETFs—an example of such an algorithm is the open-source software Riskfolio-Lib.

A potential problem with the first and fourth steps, however, is that much of the financial data relevant to the financial market for ETFs is available only in a format that is unacceptable to, and, therefore, incompatible with, currently available ML models suitable for predicting the performance or returns of ETF market; this may be one reason why, until now, there have been no available and reliable macroeconomic ETF market predictions for use by investors.

In an embodiment, although LightGBM, a gradient-boosting algorithm (ML model), can be used for predicting performance of the ETF market, LightGBM accepts input data only in a two-dimensional spreadsheet format (e.g., vertically stacked rows that include financial-data components in aligned columns) such as, for example, in a Pandas DataFrame.

But some data relevant to the ETF market is available only in an incompatible format. For example, Morningstar ETF data currently is available only in XML format, with Morningstar currently generating one XML file per ETF per day.

Each XML file has a nested, leaf-branch format of financial-data components per the following example:

```
ELEMENT 1
  sub element 1
  sub element 2
    sub-sub element a
      sub-sub-sub element i
    sub-sub element b . . .
ELEMENT 2 . . .
```

In the preceding example, financial-data component “sub element 1” is a leaf node because it has no “children,” whereas component “sub element 2” is a branch node because it has the following “children:” financial-data components “sub-sub element a,” “sub-sub-sub element i,” and “sub-sub element b,”

Although XML parsers exist, they typically provide inconsistent schemas for complex data sets because converting a complex XML file into a spreadsheet format can require decision making about how each sub element is arranged in the spreadsheet data structure.

Consequently, in an embodiment, a parsing-and-flattening routine can convert an XML file, such as a Morningstar XML file, into a spreadsheet-like row. Continuing the above XML-file example, the parsing-and-flattening routine can generate the following spreadsheet-like row, where columns of the row are separated by semicolons (“;”):
ELEMENT 1; sub element 1; sub element 2; sub-sub element a; sub-sub-sub element i; sub-sub element b; . . . ; ELEMENT 2;

Each column can include the data-component name (e.g., “sub element 1”) and a value (e.g., an ETF value such as the highest trading price of the day) of the data-component, or just may include the data-component value, where the respective data-component name for each of the columns is known a priori (e.g., each column of the row is assigned to a respective data component).

Or, to keep track to which “tree” of the XML file a data-component belongs, each column of the row may include a “key” that includes both a hierarchal path name, and the value of the data component. That is, continuing the above XML-file example, the row can include the following hierarchal path names (columns separated by “;”) and single-digit data-component values, where the data-component value corresponds to the last data-component name in the hierarchal path name:
ELEMENT_1_0; ELEMENT_1_sub_element_1_5;
ELEMENT_1_sub_element_2_4;
ELEMENT_1_sub_element_2_sub_sub_element_a_9;
ELEMENT_1_sub_element_2_sub_sub_element_a_sub_sub_sub_element_i_7;
ELEMENT_1_sub_element_2_sub_sub_element b_8; . . . ; ELEMENT 2_6; . . .

For example, “ELEMENT_1_sub_element_2_sub_sub_element a 9” indicates that “sub_sub_element_a” has a value of “9”.

Assigning such keys (e.g., hierarchal names and values) for each column, for example, allows detecting if a component is missing from an XML file so that the columns can be kept aligned.

If a data component is missing from an XML file, the data component can still be included in the row with a default value such as “0” or “null.”

Likewise, if the financial-data component is present but if the data-component value is missing or otherwise is not provided, instead of eliminating the corresponding column from the row, the data component can be given any suitable default value such as “0” or “null” to maintain a spreadsheet-like data structure with all the rows including the same number of aligned columns.

As described above, in an embodiment, the value of a data component can be appended, using underscores, to the hierarchal-path name instead of being stored separately from the name.

Furthermore, the keys (e.g., the data-component names and values) are initially extracted from an XML file as strings (e.g., a standard format, or “type”, for storing data). If an extracted string, or a portion thereof, needs to be in a type such as numeric, alphanumeric, etc., then the flatting-and-parsing technique can perform, as a separate step, a string-to-type conversion of some or all of the data-component names or values.

Because the above-described flatting-and-parsing technique effectively “makes few assumptions” about an XML schema of an XML file beyond the file's nested structure and some data components being a parent or child of other data components, the technique is flexible and can be used with many different XML schemas.

If the flattening-and-parsing technique is applied to XML files with different keys, then the discrepancy between the keys may be handled by adjustments to data-mapping or to post-processing code or logic. For example, attributes and nesting levels may vary widely between XML files, and this wide variation may call for a highly flexible flattening-and-parsing routine. That is, for the described application, the flattening-and-parsing routine can be configured to be flexible to handle different ETFs because, for example, some ETFs can have different attributes than other ETFs (e.g., attributes for equity ETFs may be different from attributes for fixed-income ETFs).

Table I shows an example of two ETFs and their attributes, where each attribute is represented by a respective column:

| | | | | E | F |
|---|---|---|---|---|---|
| A | | | | Market | Clos- |
| ETF | B | C | D | Capital- | ing |
| Ticker | Date | P/E | P/B | ization | Price |
| SPY | 2024 Jan. 1 | 0.7246148842 | 0.7176321154 | 2387 | 45 |
| SPY | 2024 Jan. 2 | 0.5633264567 | 0.07537668559 | 4369 | 66 |
| SPY | 2024 Jan. 3 | 0.6884719981 | 0.1353496854 | 3024 | 25 |
| SPY | 2024 Jan. 4 | 0.6476695604 | 0.9013244066 | 3709 | 82 |
| SPY | 2024 Jan. 5 | 0.5480012496 | 0.3318058132 | 3667 | 84 |
| VTI | 2024 Jan. 1 | 0.8063318748 | 0.8348584465 | 4676 | 90 |
| VTI | 2024 Jan. 2 | 0.9948117757 | 0.6250067306 | 4870 | 68 |
| VTI | 2024 Jan. 3 | 0.7723389364 | 0.1313733577 | 4437 | 84 |
| VTI | 2024 Jan. 4 | 0.8264927152 | 0.4516711207 | 7071 | 10 |
| VTI | 2024 Jan. 5 | 0.9290637692 | 0.7176843735 | 5406 | 4 |

Still referring to Table I, the shown attributes of the ETFs include the ETF Ticker (here “SPY” and “VTI”), the date on which the values in the row are determined, the Price-to-Earnings Ratio (P/E), Price-to-Book Ratio (P/B), Market Capitalization, and Closing Price. Other examples of attributes of the ETF include ETF performance (e.g., daily, weekly, monthly, quarterly, or yearly high and low values), allocations (weights assigned to each asset in a strategy), fees, and risk metrics.

And, as set forth above, each row represents one Morningstar XML file, which represents one day's worth of data for the identified (in the first column of Table I) ETF.

Consequently, because, in an embodiment, one may use data from more than eight hundred (800) ETFs over periods much longer than one day to train an ML model and to feed data to the trained ML model for making ETF market or return predictions, the spread-sheet-like data structure generated according to an embodiment such as described above can be quite large.

A reason for developing the above-described parsing-and-flattening routine or logic (an embodiment of the Python code for this routine is appended to the end of the patent application as Appendix B) is because the data contained in the Morningstar XML files can result in a better prediction (e.g., trend forecasting) of the ETF financial market as compared to accessible data already in formats suitable for ML models.

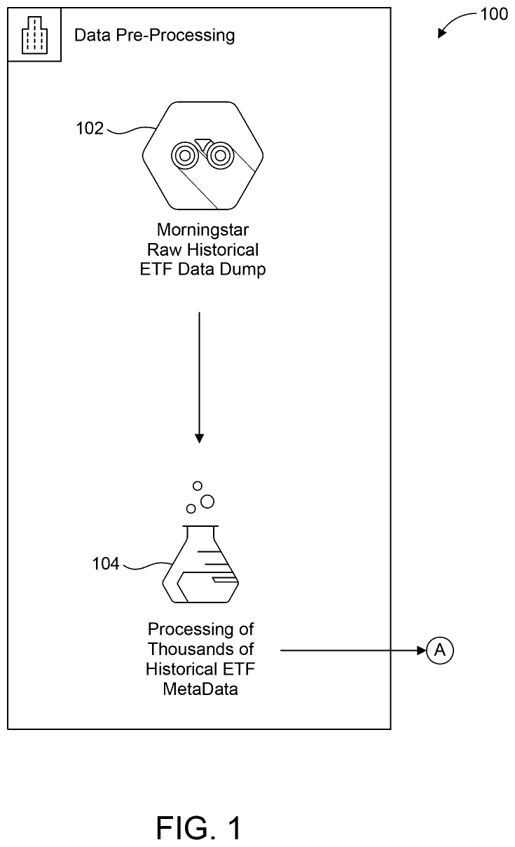

FIG. 1 is a flow diagram 100 of the above-described parsing-and-flattening routine (e.g., procedure, method, or workflow), which, in general, can be called a data pre-processing routine, according to an embodiment.

At 102, one or more XML files, such as from Morningstar XML files, including data (e.g., attributes) related to the ETF (or other) financial market, are downloaded (e.g., dumped), to local memory.

And at 104, the XML files stored in memory are parsed and flattened as described above to generate a spreadsheet-like data structure having rows and columns, such as a Pandas data frame.

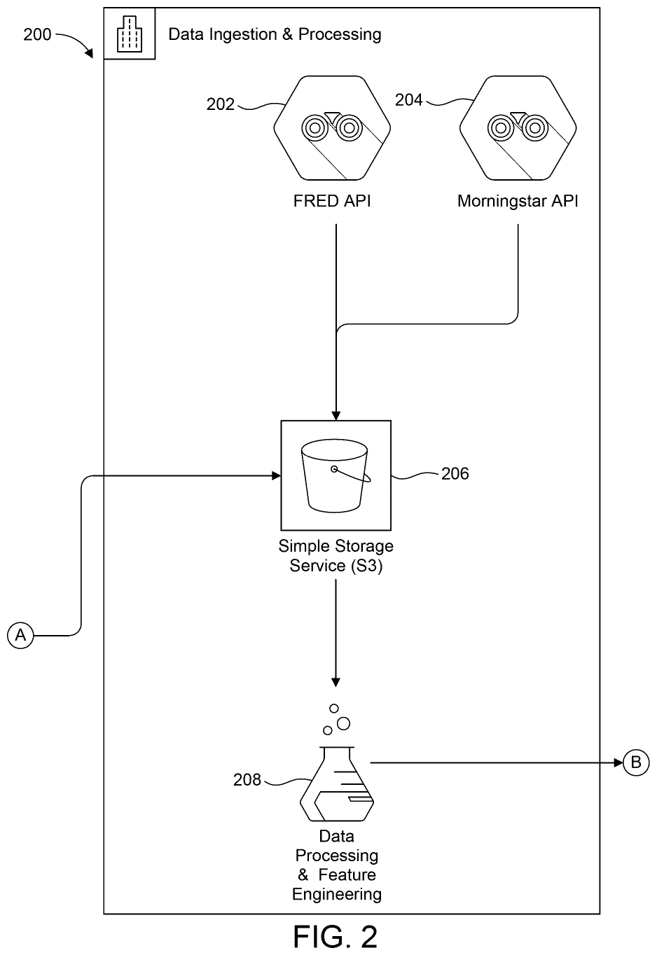

The workflow represented by the flow diagram 100 continues to FIG. 2 via reference node A.

It is possible that, in the future, Morningstar and/or other market-data providers may provide ETF financial or other data in one or more formats suitable for input to an ML model, in which case pre-processing the ETF financial data using the above-described flattening-and-parsing technique may not be needed.

Furthermore, in an embodiment, complexities of, and challenges with, the above-described flattening-and-parsing routine can include memory management, because there may be thousands of ETF (or other) XML files generated per month, and a computer system such as the computing circuit 600 can loop through all these XML files per the above parsing-and-flattening routine to put all of the data into a spreadsheet row-and-column structure such as a Pandas data frame, and this structure/data frame can be very large.

Examples of financial data sources for ETFs other than Morningstar include Federal Reserve Economic Data (FRED) and End of Day (EOD) historical data.

And examples of data components (hereinafter called “data features,” or just “features”) included in such data sources include Historical Market Data ((e.g., Morningstar data including daily open, high, low, and close prices, price-to-earning ratios, or price-to-book ratios), trading volumes, corporate earnings, cash flows, or revenue forecasts), interest rates (e.g., FRED data including federal-funds rate or current treasury yields), or macroeconomic data for each of one or more countries/regions (e.g., U.S., Europe), examples of which include FRED employment data, gross domestic product (GDP), rate of inflation, or one or more other FRED economic indicators. As is evident, at least some of this data (e.g., rate of inflation) is not specific to the ETF market.

After available data is put into a format compatible with the ML model being used, one determines with what available data features to train the ML model, what data features to input to the trained ML model, and what unavailable data features to engineer and with which to train the ML model and to input to the trained ML model. Regarding training of the ML model, one could train the ML model with all available data, or a large subset thereof, but this may require too much processing power or take too much processing time relative to the computing machine being used to train the ML model.

Feature engineering (e.g., generation) entails applying, to one or more available data features (sometimes called “raw data features” or “raw data), one or more mathematical transformations to generate one or more engineered features such as, e.g., lags, moving averages, or differences.

For example, a lag captures, for a financial asset such as an ETF, a temporal dependency in one or a combination of available features over a respective time period. For example, one or more lags can be determined showing a rate of change in a financial asset's closing price over respective periods of one day to over one year.

A moving average captures, for a financial asset such as an ETF, an average of a feature over a shorter time window that moves within a larger time window to smoothen short-term fluctuations of the feature and to highlight longer-term trends in the feature. For example, averages of price-to-earnings (P/E) ratio for a financial asset can be taken over a 5-day window that can move back and forth through a time period of one year in increments of one day.

A difference captures a difference in a feature of a financial asset, such as an ETF, over a period of time. For example, a difference feature can capture a week-to-week difference or a month-to-month difference in the closing price of a financial asset.

The following is a summary of an embodiment of a workflow that takes non-readily available (at least non-readily available for use by an ML model) Morningstar data and transforms it into a usable historical data set to be used in predictive modeling of a financial market. In other embodiments, some steps of the workflow may be omitted, or some step not included in the following summary may be added.
1) User/implementer of the workflow collaborates with Morningstar to request a custom dataset (including detailed historical information) for financial assets (e.g., ETFs) spanning multiple years.
2) User/implementer of the workflow receives, from Morningstar, many (e.g., tens of thousands of) XML files containing the financial-asset (e.g., ETF) information requested at (1) and stores these files in electronic memory (see 102 of the flow diagram 100 of FIG. 1).
3) User/implementer of the workflow parses and flattens the received XML files, which are in a “tree” format per above. The resulting structure of the parsed-and-flattened XML files can be called a “flattened-dictionary structure” (see 104 of the flow diagram 100 of FIG. 1).
4) User/implementer of the workflow combines the parsed-and-flattened outputs from all of the XML files into a single Pandas data frame (per above, a Pandas data frame can be like a spreadsheet with rows and columns, see 104 of FIG. 1).

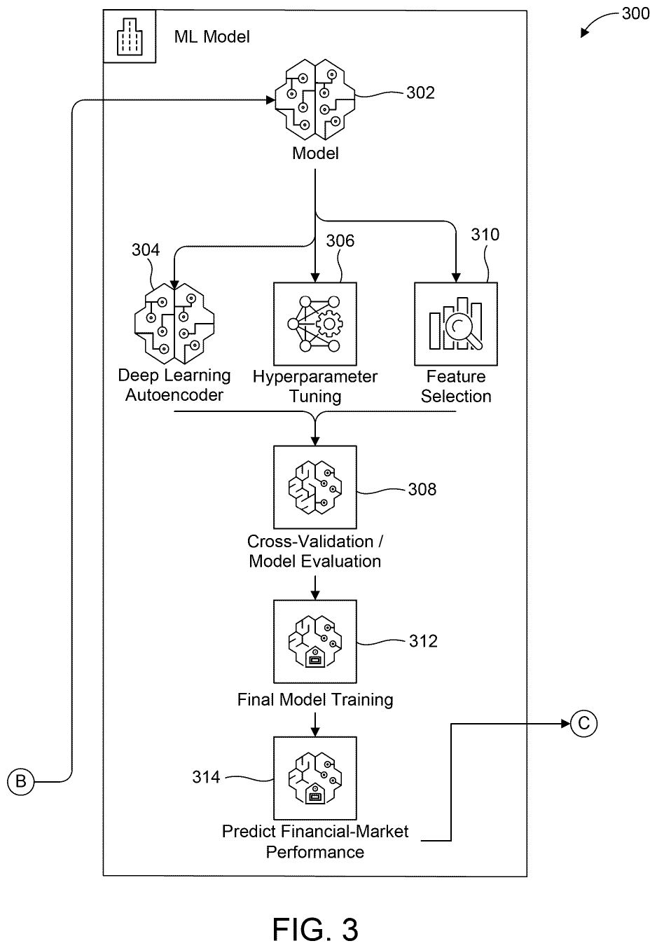

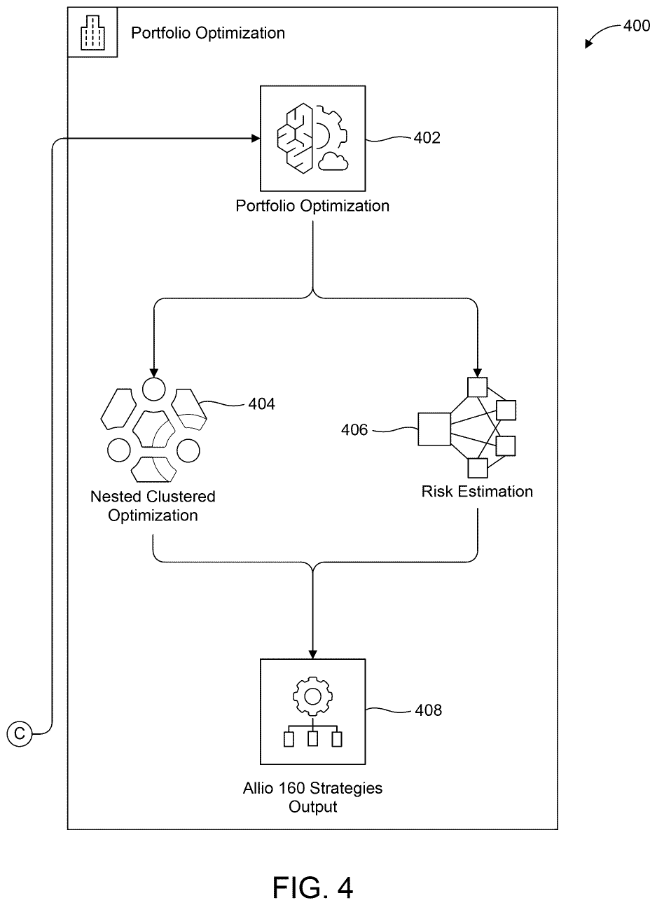

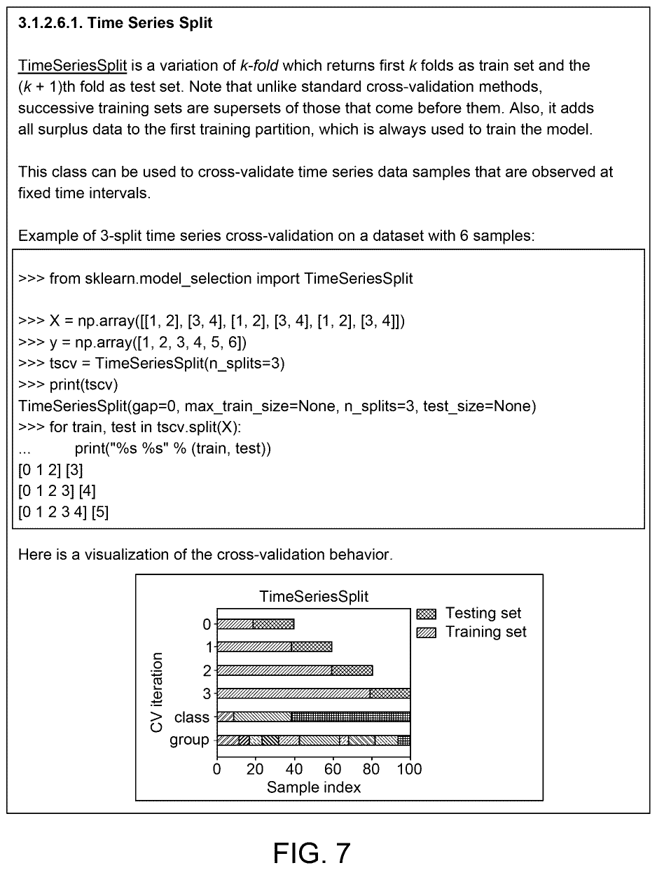

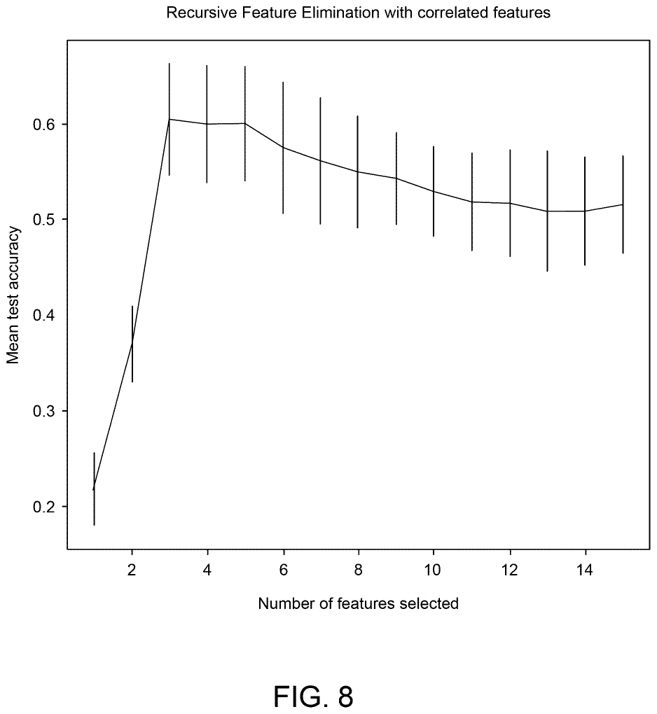

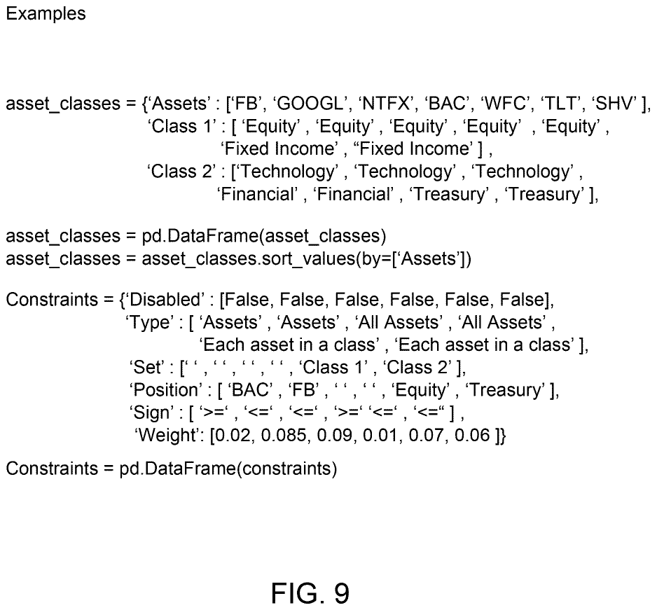

FIG. 2 is a flow diagram 200 of a procedure for combining the data in the Pandas data frame with other related data for further data processing and feature engineering, according to an embodiment. Continuing with step (5) of the summary (steps (1)-(4) above):
5) User/implementer aligns the parsed-and-flattened (e.g., Morningstar) data with other related data and reference information (not necessarily data/information specific to the financial asset (e.g., ETFs), the performance of which is being predicted, such data/information can include, e.g., historical market data such as prices and volume, interest rates, macroeconomic data, employment data, or GDP) to obtain a well-rounded perspective for each member of the financial-asset type (e.g., each ETF). For example, referring to 202 and 204 of the flow diagram 200 of FIG. 2, the other related data can be FRED data received via a FRED application interface (api), EOD data, or Morningstar data (other than the parsed-and-flattened data) via a Morningstar API.
6) At 206 of the flow diagram 200 of FIG. 2, the other data received and aligned at 202 and 204 is combined with the parsed-and-flattened data, according to an embodiment. It follows from the foregoing (and as set forth below) that the disclosed workflow, and a computer system that implements the disclosed workflow, can achieve a unified dataset of historically rich financial-asset (e.g., ETF) information rarely found, or not found at all, in standard data feeds. As compared to existing workflows, computer systems, or other systems that analyze investment vehicles (assets) and generate investment data, the disclosed workflow and system can enable a more-comprehensive foundation for advanced modeling, back testing, and exploratory analyses. For example, standard ETF data feeds rarely have historical data readily available. But the disclosed workflow and system are capable of formatting and combining disparate datasets and continually integrating new data into a unified dataset made suitable (e.g., optimized) for use in machine learning by an ML model, for example per 202-206 of the flow diagram 200 of FIG. 2.
7) Still referring to FIG. 2, at 208 of the flow diagram 200, the workflow processes the data generated and stored at 206 to generate training data for training the ML model, processes any other data to be used in conjunction with the ML model, and, as described above, engineers (e.g., generates) one or more features (e.g., lag, moving average, difference) that are not already available as part of the data generated and stored at 206. The workflow then provides the training data, any other data, and potentially one or more engineered features to FIG. 3 via node B.
8) Referring to the flow diagram 300 of FIG. 3, in an embodiment, an ML model 302 used by an embodiment of the workflow or system receives the training data, other data, and, if generated, one or more engineered features from 208 of FIG. 2, and is trained, and otherwise is configured, to predict the performance, e.g., a return, for a financial market (e.g., the ETF market), and potentially predict a return for each financial asset (e.g., each ETF) in the financial-market dataset, for a period of time (e.g., the next three months) in the future.
9) In an embodiment, the ML model 302 is trained/configured/used according to the following workflow methodology:
   a. Algorithm: In an embodiment, the ML model 302 is the open-source LightGBM (Light Gradient Boosting Machine) because of LightGBM's efficiency and performance in handling relatively large datasets and relatively complex relationships to generate results that can include predictions.
   b. Deep Learning Autoencoder 304: Neural network designed to create a condensed representation of the data input (e.g., the data output from the ML model 302), looking to capture non-linear and relational effects (impacts) not found through the LightGBM algorithm. These non-linear relational effects can be used as one or more feature inputs to the LightGBM model. That is, these one or more feature inputs can be fed back to the input of the ML model 302 during a prediction cycle, or the Deep Learning Autoencoder 304 can receive, directly, the data and engineered features from 208 of the flow diagram 200 of FIG. 2, generate one or more feature inputs from the received data and engineered features, and provide these one or more feature inputs of data to the input of the ML model 302. Or, the one or more feature inputs can be data types that the ML model 302 can be trained to recognize during a prediction cycle. An example of a non-linear effect (impact) that can be used as a feature input to the LightGBM model is that if the price-to-earnings (P/E) ratio of an ETF other than SPY goes above 30, then the change in the price of the ETF SPY jumps 3%, but if the P/E of any ETF other than SPY goes below 30, then this does not have a material change on price of SPY.
   c. Hyperparameter Tuning 306: In an embodiment, key parameters of the ML model 302, such as the (i) number of boosting rounds, (ii) learning rate, (iii) max bin, or (iv) number of leaves, can be tuned to improve, or even to optimize, the performance of the ML model 302, for example as described below in the discussion of Model Evaluation Metrics.
   d. Validation Strategy 308: An embodiment of the workflow can validate training of the ML model 302 by implementing a walk-forward cross-validation strategy (this step is suited for panel time-series data to provide or to improve the robustness and reliability of the ML model 302's, or another artificial-intelligence model's, predictive power over time).
      Referring to FIG. 7 and the following text, an example of a validation strategy for the ML model 302 taken from the publicly available Scikit-Learn documentation is described, according to an embodiment. The y-axis TimeSeriesSplit chart shows the number of folds, k, which represents the iteration of a training/testing cycle. For example, if a spreadsheet-like data set (described above) has 100 rows, and 10-fold cross-validation is used, the data is split into 10 folds of 10 rows each. The ML model 302 (or other ML model) is trained 10 times. In the first cross-validation (training) iteration k=1, fold 1 is used as the test set of data, and folds 2-10 are used as the training set of data. In the second cross-validation iteration k=2, fold 2 is used as the test set of data, and folds 1 and 3-10 are used as the training set of data. In the third cross-validation iteration k=3, fold 3 is used as the test set of data, and folds 1-2 and 4-10 are used as the training set of data, and so on.
10) The trained ML model 302 is evaluated as follows:
   i. Feature Selection 310:
      1. Recursive Feature Elimination (RFE): In an embodiment, a machine-learning or other artificial-intelligence model, such as the ML model 302, can employ RFE with cross-validation to select the most-relevant features to be used while the ML model 302 is predicting performance (e.g., returns) of a financial market (sometimes called a prediction cycle). This process iteratively removes the least-important features and builds models to identify which set of features contribute the most to prediction accuracy. Employing RFE eliminates noise from the dataset such that only features which contribute significantly to prediction accuracy are included in the modeling.
      2. Said another way, RFE is a feature-selection algorithm that works by iteratively removing features and training/retraining a model, such as the ML model 302, until the desired number of features is reached. It is typically a backward-feature-selection process, meaning the process starts with all features and progressively eliminates the least important features based on their impact on model performance.
      3. In an embodiment, RFE works as follows:
         a) Initial Model Training: A machine learning (ML) model (e.g., linear regression, random forest) such as the ML model 302 is trained on the entire dataset.
         b) Feature Ranking: The ML model assigns importance scores to each feature (e.g., coefficients in linear models, feature importances in tree-based models).
         c) Feature Elimination: The least important feature(s) are removed based on their ranking by the importance scores in 2.
         d) Retraining: The model is retrained on the reduced feature set.
         e) Iteration: Steps 2-4 are repeated until a desired number of features is reached.
   iv. FIG. 8 is an example graph from the Scikit-Learn documentation, according to an embodiment.
b. Model Evaluation Metrics 308:
   i. Spearman Rank Correlation (Final Model Training 312): The performance of embodiments of machine-learning or other artificial-intelligence models, such as the ML model 302, can be evaluated using the Spearman rank correlation coefficient to measure the strength and direction of association between predicted returns of a financial asset (e.g., ETFs, mid-cap stocks) or of one or more members of the financial asset (e.g., SPY (ETF), Valvoline (mid-cap stock)) and actual returns for the financial asset or of one or more members of the financial asset during a particular period (e.g., a 3-month window) for which the returns of the financial asset (including its members) are known. This strength-and-direction-of-association metric can be particularly useful in understanding the ordinal relationship between the predictions and the actual values.
   ii. The Spearman Rank Correlation can range between 1 and −1. A rank of 1 for the relationship between two variables would mean a perfect positive correlation (i.e., an increase in one variable corresponds with an increase of equal magnitude in the correlated variable). Conversely, a rank of −1 for the relationship between two variables would mean a perfect negative correlation (i.e., an increase in one variable corresponds with a decrease of equal magnitude in the correlated variable). A rank of zero would mean the variables are not correlated.
11) Still referring to the flow diagram 300 of FIG. 3, at 314 the trained ML model 302 can be deployed as follows, according to an embodiment:
   a. In an embodiment, a prediction of the ETF market (e.g., ETF returns) for three months out is used to determine a good, or the best, ETF portfolio for the next three months using one of the following methods, it being understood that prediction of returns for another financial asset or market for any time frame can be made in a similar manner:
      i. At 314, the ML model 302 predicts the performance (e.g., returns) of the ETF market.
      ii. In an embodiment, a human (e.g., a financial planner, portfolio manager) can craft an ETF portfolio based on the predicted three-month return. For example, in a three-security portfolio of ETFs, SPY, VTI, and BIL, a human could assign weights such as SPY: 50%, VTI: 40%, and BIL: 10%, based on the predicted three-month return of the ETF market. Assigning weights means that by value, the portfolio is 50% SPY, 40% VTI, and 10% BIL.
      iii. FIG. 4 is a flow diagram 400 of a method for developing a portfolio of financial assets in response to a prediction of the performance (e.g., returns) of a financial market (e.g., ETFs) made at 314 of the flow diagram 300 of FIG. 3 (the workflow passes, via node C, data corresponding to the market prediction made at 314 to 402 of the flow-diagram 400 for developing, and perhaps even optimizing, a portfolio of assets of the predicted market).
      iv. In an embodiment, at 404, the trained ML model 302, or another trained ML model, uses Riskfolio-lib's nested clustered optimization methodology, which employs the Gerber statistic for similarity and, at 406, employes covariance-estimate matrices to estimate risk relative to the market, the performance of which was predicted, to improve (e.g., maximize) utility and to reduce (e.g., minimize) variance as a risk measure (e.g., at a high level, one can think of “utility” as the level of happiness or satisfaction an investor gets from his/her portfolio's performance; for example, an investor might prefer a portfolio with a slightly lower expected return but with much lower risk, if that portfolio provides a higher level of utility (happiness or satisfaction) due to the investor's risk aversion).
      FIG. 9 is an example list of constraints from the publicly available Riskfolio-lib documentation, according to an embodiment.

The constraint looks like this:

| Index | Disabled | Type | Set | Position | Sign | Weight |
|---|---|---|---|---|---|---|
| 0 | False | Assets | | BAC | >= | 0.02 |
| 1 | False | Assets | | FB | <= | 0.085 |
| 2 | False | All Assets | | | <= | 0.09 |
| 3 | False | All Assets | | | >= | 0.01 |
| 4 | False | Each asset in | Class 1 | Equity | <= | 0.07 |
| | | a class | | | | |
| 4 | False | Each asset in | Class 2 | Treasury | <= | 0.06 |
| | | a class | | | | |

12) In an embodiment, at 408, the workflow for portfolio development or optimization can utilize constraints in investment-portfolio strategies such as the following investment-portfolio strategies (e.g., total strategies up to 160). In an embodiment, each of the following strategies (and other strategies) can be tailored with specific constraints to meet unique requirements and investment goals. For example, in an embodiment, an investor, investor advisor, portfolio manager, or other person or workflow can modify each of the eight (8) parent strategies listed below by selecting a risk level (1-10) and selecting inclusion or exclusion of cryptocurrency, resulting, for this example, in one hundred sixty (160) unique strategies.
   a. Eight (8) Parent Strategies: Parent strategies include broad strategies setting the foundation for sub-strategies.
      i. Core Macro: Core strategies include a balanced mix of equities, bonds, and other asset classes. A goal of a core strategy can be to create a well-rounded investment approach that provides potential for growth through equities while seeking stability and income through bonds. By carefully allocating invested funds to different asset classes, core strategies can aim to achieve long-term financial objectives while managing risk based on an investor's risk tolerance and investment time horizon.
      ii. Smart Beta: Smart-beta strategies combine passive (e.g., not actively choosing (picking) individual securities, but investing in an index like the S&P 500) and active investing (actively picking individual securities to be held in a strategy) by selecting and weighting securities based on specific factors (e.g., the value of the security, or whether those securities have seen strong returns recently) to potentially outperform traditional indices. One aim of these smart-beta strategies is to achieve targeted investment objectives like enhanced returns, reduced risk, or improved diversification through a systematic and rules-based approach. Smart beta strategies can provide investors with exposure to specific factors believed to drive outperformance or to complement traditional approaches in their portfolio. One can allocate capital to alternative ETFs compared to traditional cap-weighted indexes such as QUAL, which focuses on companies with stable earnings growth, for example.
      iii. Growth: Growth strategies focus on investing in companies (or other entities) with strong potential to expand their revenues and earnings. Growth strategies can be suited for investors with a higher risk tolerance who are seeking long-term capital appreciation and are willing to accept higher volatility in pursuit of potentially higher returns.
      iv. Dividend: Dividend strategies focus on selecting stocks that pay regular dividends to shareholders. A goal of a dividend strategy can be to generate a steady stream of income for investors by holding companies (or other entities) that distribute a portion of their earnings in the form of dividends. This strategy is often favored by income-oriented investors seeking a reliable cash flow while potentially benefiting from long-term capital appreciation.
      V. Risk Parity: Risk-parity strategies can aim to achieve balanced risk across different asset classes in a portfolio. For example, in a risk-parity strategy, the allocation of assets can be based on their risk contributions rather than their traditional market capitalization weights. A goal of this strategy can be to diversify risk and to create a portfolio where each asset class contributes equally to the overall risk, potentially leading to a more stable and consistent performance in various market conditions.
      vi. Value: Value strategies can include the seeking out of undervalued stocks compared to their intrinsic worth. Investors using this strategy may look for companies (or other entities) with lower price-to-earnings (P/E) ratios, price-to-book (P/B) ratios, or other fundamental valuation metrics relative to their peers. A goal of a value strategy can be to identify stocks with potential for price appreciation as the market recognizes and reflects their true values over time.
      vii. Trend Following: Trend-following strategies can seek to identify and capitalize on prevailing market trends. Investors using this strategy typically buy assets that have been rising in price, indicating an uptrend, and sell assets that have been declining in price, indicating a downtrend. One goal of a trend-following strategy is to ride the momentum of trends and potentially profit from their continuation, regardless of the underlying fundamentals of the one or more assets in the portfolio.
      viii. Disruptive Technologies: Disruptive-technologies strategies can focus on investing in companies (or other entities) involved in innovative and transformative technologies that can significantly disrupt traditional industries. Such strategies can seek to capitalize on technological advancements and companies (or other entities) at the forefront of innovation, potentially offering substantial growth opportunities. Investors using this strategy typically aim to benefit from the long-term potential of disruptive technologies, which can revolutionize various sectors and drive significant market returns.
13) Further at 402, 404, or 408, in an embodiment, one can develop, improve, or even optimize an investment portfolio by implementing a respective one or more of the following investment-portfolio sub-strategies for each of one or more of the above-described investment-portfolio parent strategies.
   a. 16 Sub-Parent Strategies: In an embodiment, each parent strategy can be divided into two respective sub-parent strategies, for example, one including crypto assets and one without crypto assets (if the number of parent strategies is different from eight (8), then the number of sub-parent strategies can be different from sixteen (16)).
   b. 10 Risk Levels per Sub-Parent Strategy: In an embodiment, each sub-parent strategy is further divided into ten (10) different risk levels to cater to various risk preferences as follows:
      i. Most Conservative: A portfolio with this risk-level is appropriate for the most risk-averse investor, designed to provide capital preservation with minimal exposure to market volatility.
      ii. Conservative: A portfolio with this risk-level is designed for risk-averse investors to deliver stable returns with relatively lower risk levels with a focus on capital preservation.
      iii. Moderately Conservative: A portfolio with this risk-level is designed for investors who are slightly less risk-averse but still prefer stability and capital preservation. A portfolio developed for this risk-level strategy will hold a slightly higher proportion of equities compared to the conservative portfolio.
      iv. Balanced-Conservative: A portfolio with this risk-level is designed for investors who are slightly more risk-tolerant and who prefer stability and capital preservation but are comfortable with marginally more risk in pursuit of marginally higher expected returns.
      v. Balanced: A portfolio with this risk-level is designed for investors who are aiming for an equilibrium between risk and return. A balanced portfolio holds a roughly equal allocation of stocks and bonds with a slight tilt towards bonds.
      vi. Balanced-Aggressive: A portfolio with this risk level is designed for investors who are seeking growth but with a focus on a balanced risk profile. A balanced-aggressive portfolio holds a roughly equal allocation of stocks and bonds with a slight tilt towards stocks.
      vii. Moderately Aggressive: A portfolio with this risk level is designed for investors aiming for growth and comfortable with market volatility. It holds a higher proportion of stocks with a smaller bond component.
      viii. Aggressive: A portfolio with this risk level is suitable for growth-focused investors comfortable with relatively more market volatility. An aggressive portfolio is heavily weighted towards stocks with a small bond allocation.
      ix. Highly Aggressive: A portfolio with this risk level is designed to offer investors high growth potential with significant market volatility. A highly aggressive portfolio predominantly holds stocks with a very small bond allocation.
      X. Most Aggressive: A portfolio with this risk level represents the zenith of risk engagement, targeting maximum.return potential with the highest degree of market volatility. A most-aggressive portfolio holds mostly stocks with a minimal bond allocation.

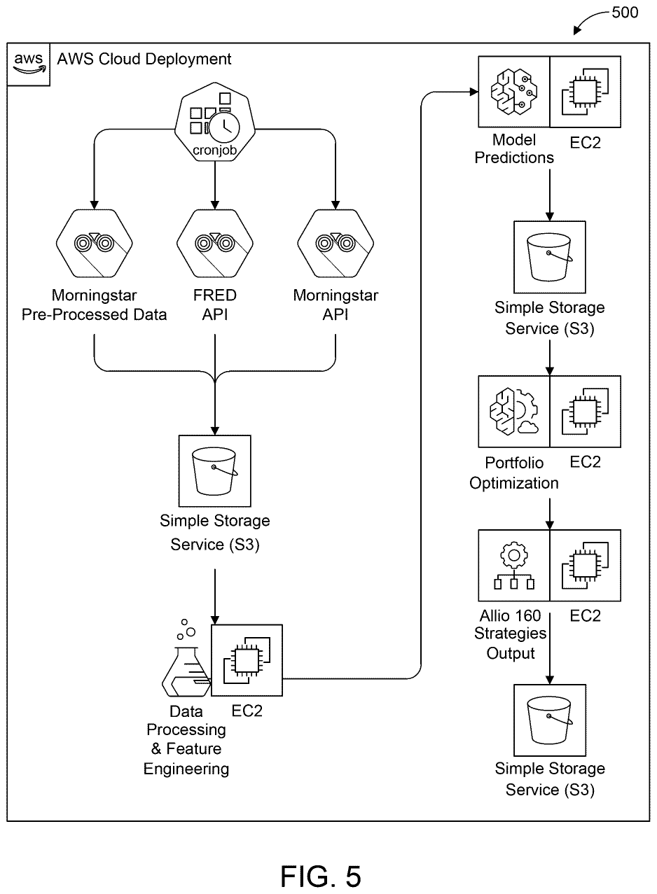

FIG. 5 is a flow diagram 500 of a cloud implementation of the workflow described above in conjunction with FIGS. 1-4, according to an embodiment. FIG. 5 includes many of the same steps as described in conjunction with FIGS. 1-4. “EC2” represents Amazon EC2, or Elastic Compute Cloud, which is a web service that can be used to implement the workflow, and which provides scalable virtual servers (also known as instances) to run applications. EC2 allows users to provision and manage these virtual servers, adjusting their computing capacity as needed, without the need for physical hardware. That is, EC2 provides on-demand computing power within the Amazon Web Services (AWS) cloud.

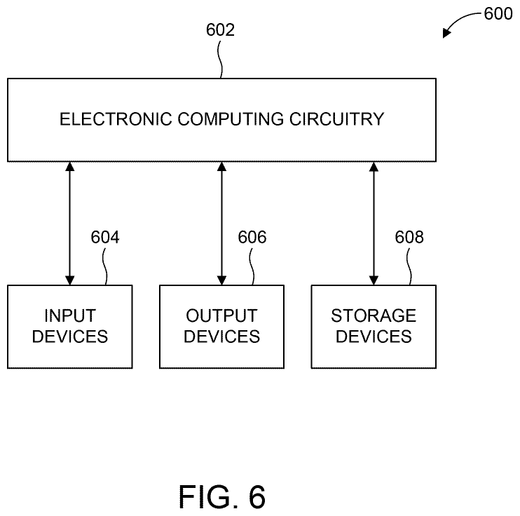

FIG. 6 is a functional block diagram of a computing system 600, which can include electronic computing circuitry 602, in accordance with an embodiment. The computing system 600 can be configured to perform (e.g., implement, execute) one or more embodiments of the workflow described in conjunction with FIGS. 1-5 and to perform any other procedures described herein. The electronic computing circuitry 602 generally may be configured to perform various computing functions, which may include, for example, executing specific instructions that may be embodied in software, or performing other specific functions, such as processing data according to the specific instructions, or by other means. For example, the electronic computing circuitry 602 can be configured to execute instructions corresponding to the ML model 302 of FIG. 3, and otherwise to execute the ML model 302 and other workflows, procedures, or methods disclosed herein. The electronic system 600 also can include one or more input devices 604, which may include an audio input device (e.g., one or more microphones) or a manual input device such as a keyboard, a mouse, a tactile input device, or other similar devices, which may be coupled to the electronic computing circuitry 602 so that user preferences and instructions may be communicated to the electronic computing circuitry. The electronic computing system 600 also may include one or more output devices 606 coupled to the electronic computing circuitry 602. Suitable output devices 606 can include an audio speaker, a display device, as well as other output devices that may depend on a specific function or configuration of the system 600. One or more data storage devices 608 also can be coupled to the electronic computing circuitry 602 to permit storage and retrieval of data or instructions from storage media, which may be located within the electronic computing circuitry 602, or located external to the electronic computing circuitry. Examples of suitable storage devices 608 can include magnetic storage devices, such as hard-disk devices, or floppy disks, tape cassettes, solid-state drives, electrically erasable and programmable read-only memory (EEPROM) or other similar devices. Other suitable storage devices 608 may include optical storage devices, such as compact disk read-only memory (CDROMs), compact disk read-write (CD-RW) memory devices, and digital video disks (DVDs), although other suitable alternatives exist.

### CONCLUSION

In an embodiment, the above-described workflow can be a structured approach to predicting 3-month-ahead (or any other suitable time frame) returns for ETFs (or any other financial market or asset). Historical ETF data not readily available, for example from Morningstar, can be (e.g., heavily) processed to be used for analysis. By combining historical market data, interest rates, and macroeconomic indicators with advanced machine-learning techniques like LightGBM, a deep neural network autoencoder, robust feature engineering, and selection methods, one or more embodiments of the systems and methods disclosed herein can generate accurate and reliable financial-market predictions, which can serve as crucial inputs for investment-portfolio improvement (e.g., portfolio optimization), facilitating the design of a diverse range of portfolio strategies with specific constraints. In an embodiment, the workflow's use of Riskfolio-lib's nested clustered optimization methodology can improve, or even optimize, portfolios for utility and variance, thus supporting strategic financial decision making.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

### APPENDIX B

[symbol]

[symbol]

1. A method, comprising:
training a machine-learning model with financial data;
determining a portion of the financial data to input to the trained model;
predicting, with the machine-learning model in response to the portion of the financial data, future returns of a financial market during a time window; and
constructing an investment portfolio of one or more assets of the financial market in response to the future returns.

2. The method of claim 1 wherein training the machine-learning model comprises training the machine-learning model with a walk-forward cross-validation strategy.

3. The method of claim 1 wherein training the machine-learning model comprises training and cross-validating the machine-learning model with a number of folds.

4. The method of claim 1 wherein determining a portion of the financial data to input to the trained model comprises iteratively removing least-important data features from the portion of the financial data until only a threshold number of data features are left.

5. The method of claim 1 wherein training the machine-learning model and determining a portion of the financial data to input to the trained model comprises:
training the model with the financial data;
assigning, with the model, a respective importance score to each feature;
removing at least one feature in response to the respective importance score of each of the at least one feature; and
repeating the training, assigning, and removing at least one time.

6. The method of claim 1 wherein training the machine-learning model and determining a portion of the financial data to input to the trained model comprises:
training the model with the financial data;
assigning, with the model, a respective importance score to each feature;
removing at least one feature having a lowest importance score; and
repeating the training, assigning, and removing at least one time.

7. The method of claim 1, further comprising generating the financial data by:
parsing and flattening a first set of financial data;
combining the parsed-and-flattened first set of financial data with a second set of financial data.

8. The method of claim 1, further comprising, before predicting, with the machine-learning model, the future returns of the financial market, evaluating the model using the Spearman rank correlation coefficient.

9. The method of claim 1 wherein constructing the investment portfolio comprises estimating risk of the investment portfolio using a nested clustered optimization methodology.

10. An electronic computing circuit configured to:
train a machine-learning model with financial data;
determine a portion of the financial data to input to the trained model;
predict, with the machine-learning model in response to the portion of the financial data, future returns of a financial market during a time window; and
construct an investment portfolio of one or more assets of the financial market in response to the future returns.

11. The electronic computing circuit of claim 10, further configured to train the machine-learning model with a walk-forward cross-validation strategy.

12. The electronic computing circuit of claim 10, further configured to train the machine-learning model by training and cross-validating the machine-learning model with a number of folds.

13. The electronic computing circuit of claim 10 configured to determine a portion of the financial data to input to the trained model by iteratively removing least-important data features from the portion of the financial data until only a threshold number of data features are left.

14. The electronic computing circuit of claim 10 configured to train the machine-learning model and to determine a portion of the financial data to input to the trained model by:
training the model with the financial data;
assigning, with the model, a respective importance score to each feature;
removing at least one feature in response to the respective importance score of each of the at least one feature; and
repeating the training, assigning, and removing at least one time.

15. A tangible, non-transitory, computer-readable medium storing instructions that when executed by a computing circuit, cause the computing circuit, or another electronic circuit coupled to the computing circuit, to:
train a machine-learning model with financial data;
determine a portion of the financial data to input to the trained model;
predict, with the machine-learning model in response to the portion of the financial data, future returns of a financial market during a time window; and
construct an investment portfolio of one or more assets of the financial market in response to the future returns.

16. The computer-readable medium of claim 15 wherein the instructions cause the computer circuit or the other electronic circuit to train the machine-learning model and determine a portion of the financial data to input to the trained model by:
training the model with the financial data;
assigning, with the model, a respective importance score to each feature;
removing at least one feature having a lowest importance score; and
repeating the training, assigning, and removing at least one time.

17. The computer-readable medium of claim 15 wherein the instructions cause the computer circuit or the other electronic circuit to generating the financial data by:
parsing and flattening a first set of financial data; and
combining the parsed-and-flattened first set of financial data with a second set of financial data.

18. The computer-readable medium of claim 15 wherein the instructions cause the computer circuit or the other electronic circuit, before predicting, with the machine-learning model, the future returns of the financial market, to evaluate the model using the Spearman rank correlation coefficient.

19. The computer-readable medium of claim 15 wherein the instructions cause the computer circuit or the other electronic circuit to construct the investment portfolio by estimating risk of the investment portfolio using a nested clustered optimization methodology.
